(19) United States
(12) Patent Application Publication
(10) Pub. No.: US 2005/0260551 A1
(43) Pub. Date: Nov. 24, 2005

(54) Reading book including partially electronic page display

(76) Inventors: Aaron Cole Rubin, Tucson, AZ (US); Alexandre Rex Tumlinson, Tucson, AZ (US)

Correspondence Address: WEISS & MOY PC, 4204 NORTH BROWN AVENUE, SCOTTSDALE, AZ, 85251, US

(21) Appl. No.: 10/403,418

(22) Filed: Mar. 27, 2003

(51) Int. Cl. G09B 5/00

(52) U.S. Cl. 434/317

(57) ABSTRACT

A reading book including a partially electronic page display provides a system and method for implementing interactive and/or animated books without the cost associated with typical electronic books, while retaining the multiple page features of a traditional printed book. The reading book may be a split-page design, where a portion of a reader's view is provided by a fixed electronic display, while a second portion is provided by a plurality of movable pages that may be recirculating electronic pages or printed pages. Alternatively or in concert, the reading book may include partial page areas implemented with electronic displays. Page selection via turning may be detected by optical, electronic or mechanical sensors and the display contents synchronized or activated in response to detected page turning activity.

### BACKGROUND OF THE INVENTION

1. Field of the Invention

The present invention relates generally to books including children's picture or reading books and more specifically to a book including one or more electronic pages.

2. Background of the Invention

A variety of electronic books have been proposed and developed for both the children's book and other publication markets (for example adult e-books or technical manuals that include animated screens). These “books” typically provide an alternative to a traditional book, in that they replace some or all pages of a traditional book with liquid crystal display (LCD) screens or other light-emitting devices that display all of the content for a given page. Recently, a need for an electronic book that is more than just a single screen capable of displaying pages has been described and solutions have been presented. For example, U.S. Pat. Nos. 6,124,851, 6,021,306 and 5,534,888 disclose electronics book having multiple pages providing a replacement for a more traditional book, while retaining some of the look and feel of a multiple page book. The above recited patents do teach re-use of electronic pages, but typically require the reader to turn back to the beginning of the book once the last electronic page has been reached.

Other more traditional paper, laminate or cardboard page books have been modified to incorporate features such as light-emitting diodes (LEDs) that highlight or enhance areas on a page. For example, U.S. Patent Application US2002/0122250 A1 describes a book system that provides highlighting of words on a page using LEDs, U.S. Pat. No. 5,417,575 describes a book having touch sensors and LEDs used to provide an interactive book.

The cost to manufacture an electronic book is by nature, much higher than printing costs for a traditional book. The number of electronic pages is therefore a determinant in the cost of the electronic books described above.

Therefore, it would be desirable to provide an electronic book providing a cost-effective alternative to presently available electronic books, while retaining some of the traditional look and feel of a traditional multi-page book. It would further be desirable to provide a cost-effective alternative to electronic books having full page displays that provides re-use of electronic pages without loosing the look and feel of a traditional multi-page book.

### SUMMARY OF THE INVENTION

The above objective of providing a cost-effective electronic book that retains some of the look and feel of a traditional multi-page book is met in an electronic book having partial electronic reading area. The electronic book incorporates a fixed electronic display and printed or movable electronic pages viewable simultaneously to provide interactivity and animation.

In a first embodiment of the invention, an electronic display is provided on a partial area of one or more movable low-cost printed pages, providing an area of animation and/or interactivity on the one or more printed pages, without the manufacturing costs associated with a fully electronic multi-page book.

In a second embodiment of the invention, a fixed electronic display is provided in a first area of a book page and a plurality of movable low-cost printed pages or electronic pages are provided in a second area so that the fixed electronic display is visible while the movable pages are turned. If the movable pages are electronic pages, the pages can be mounted on a spindle below the fixed electronic display, so that the pages can be turned ad infinitum, re-using (by reprogramming) the movable pages as they wrap around to the viewing position.

The turning of the movable pages can be detected by a sensing mechanism and the electronic display updated in association with user selection (by turning) of the movable pages, so that user interactivity or animation in association with the movable pages can be implemented on the electronic display.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a pictorial diagram depicting an electronic book in accordance with a first embodiment of the present invention.

FIG. 2 is a pictorial diagram depicting an electronic book in accordance with a second embodiment of the present invention.

FIG. 3 is an electronic block diagram depicting circuits of an electronic book in accordance with an embodiment of the present invention.

### DETAILED DESCRIPTION OF THE PREFERRED EMBODIMENTS

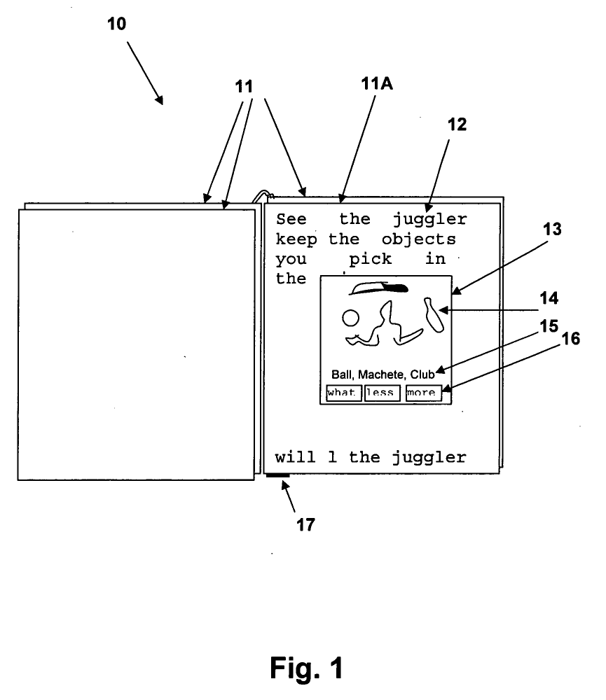

Referring now to FIG. 1, an electronic book 10 in accordance with a first embodiment of the invention is depicted. Electronic book 10 incorporates electronic display areas 13 that provides enhancement to a traditional reading book, advertising brochure, magazine, newspaper or any traditional form of printed media. The enhancement encompasses interactively changeable text, colors (including background color) and animations that are not possible with static text media, while providing a low-cost and lower power consumption alternative to an electronic book where all of the pages are completely implemented with electronic displays.

A plurality of printed pages 11 is provided with text/and or graphics, while some pages 11A incorporate electronic display areas 13 that can display either static or dynamic animated graphics 14 or text 15, enhancing the reading experience and optionally providing interactivity via touch sensors using touch screen technology, capacitive touch sensors embedded under the electronic display, membrane switches, or any suitable switching/detection mechanism to provide a signal input for interactively altering the content of electronic display area 13. Button icons 16 may be implemented as graphics and/or text on electronic display area 13 with sensors located at corresponding locations under the display or with a programmed response to a touchscreen matrix set to areas corresponding to button icons 16. Additional control of electronic display area 13 may be achieved with detectors (switches) located in the spine or other convenient location for detection the selected (open) pages. Electronic display area 13 may be activated only when the page is selected for viewing, may change in response to the turning (selection) of page 11A, for example electronic display may randomly or sequentially change in behavior each time the page 11A is selected, providing an entertaining or educational enhancement to a static book page that cannot change. The front and back cover, as well as the spine of electronic book 10 may include partial displays as well. For example, for displaying the title and other pertinent information regarding currently downloaded electronic book data, as well as cover graphics, etc.

Electronic display area 13 may also share common driver circuits with other electronic display areas and the page turn detection may select a particular electronic display area 13 from among a plurality of pages incorporating electronic display areas. A connector 17 is provided for uploading data and program instructions to internal electronics of electronic book 10, battery charging and so forth, whereby the actions of electronic display area 13 can be initialized or updated by connection to an external computer. Connector 17 may be omitted for totally wireless embodiments, where a wireless interface as described below, provides the mechanism for uploading electronic book information.

Electronic display area 13, may be an organic light-emitting diode array (OLED) a liquid crystal display (LCD), or other suitable display screen that may be conveniently attached to a page in a book such as that depicted. Preferably, the pages and the electronic display area 13 will be made of flexible material resembling that of a printed paper book, but the pages may also be made rigid. Electronic drivers required to support the operation of one or more electronic display areas 13 may be incorporated within electronics embedded in the page, provided in a front or back cover circuit mounting area, or may be embedded in the spine of the book. The above-referenced U.S. Pat. No. 6,124,851: “Electronic Book With Multiples Page Displays”, which is incorporated herein by reference, discloses a variety of driver locations and electronic page technologies that may be employed to generate full page screens. Similar technologies are also suitable for partial page screens in accordance with embodiments of the present invention.

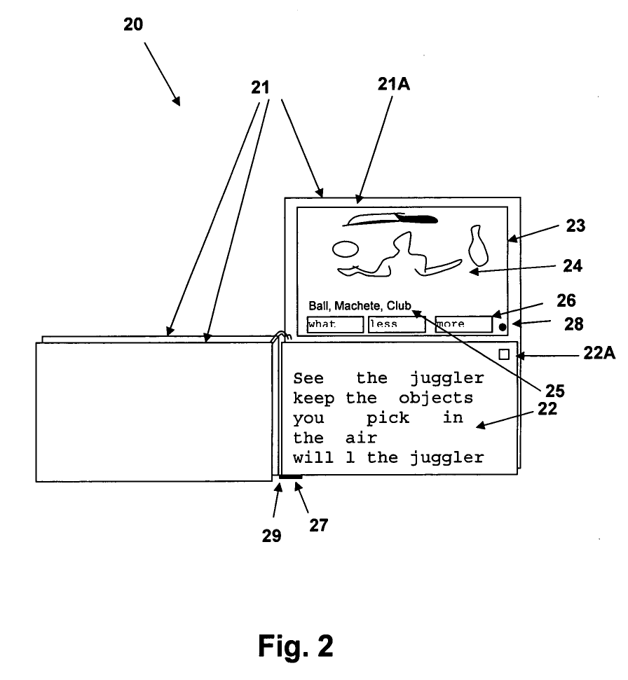

Referring now to FIG. 2, an electronic book 20 in accordance with a second embodiment of the invention is depicted. Electronic book 20 provides enhancement to a traditional reading book, advertising brochure, magazine, newspaper or any traditional form of printed media. The enhancement encompasses interactively changeable text, colors (including background color) and animations that are not possible with static text media, while providing a low-cost and lower power consumption alternative to an electronic book where each page is fully implemented with an electronic display. Or, several pages may be included that are flexible electronic or rigid display pages mounted on a spindle, so that the look and feel of a traditional book is maintained, while providing re-use of the electronic pages below the fixed display position.

A plurality of printed or moveable electronic pages 21 is provided with text/and or graphics and mounted on a spindle 29 disposed adjacent to a fixed electronic display 23 that can display either static or dynamic animated graphics 24 or text 25, as described above for the first embodiment of the present invention. Switches or other sensors may provide interactivity with electronic display 23, and may be touch sensors using touch screen technology, capacitive touch sensors, membrane switches, or the like, embedded under the electronic display or within one or more of printed or movable electronic pages 22, providing a signal input for interactively altering the content of electronic display 23. Button icons 26 may be implemented as graphics and/or text on electronic display 23 with sensors located at corresponding locations under electronic display 23 or with a programmed response to a touchscreen matrix set to areas corresponding to button icons 26.

Movable pages 22 may be removable/replaceable (if printed pages) in order to re-use the electronic portions of electronic book 20. Data storage such as read only memory (ROM), may be included within the removable printed sections and interconnected to the electronics within electronic 20 in order to provide content for fixed electronic display 23 that is coordinated with the removable pages. Optionally a CD reader or other optical/electronic reader may be incorporated within electronic book 20 for reading media supplied with removable pages. A sleeve may be incorporated within the book pages (on an inside cover or other location) for retaining such optical or electronic media.

Control of electronic display 23 (and pages 22 if electronic) may be achieved with detectors (switches) located in the spine/spindle 29 or other convenient location for detection the selected (open) pages. Page turn detection can also be accomplished by means such as optical or magnetic detection of markers 22A on a page via a camera 28 or other sensor, so that the particular selected (open) page can be determined.

Electronic display area 23 (and pages 22 if electronic), may be organic light-emitting diode arrays (OLED), liquid crystal displays (LCD), or other suitable display screens that may be conveniently fit within a book such as that depicted. Electronic drivers required to support the operation of electronic display 23 (and pages 22 if electronic) may be incorporated within electronics embedded underneath electronic display 23 (within pages 22 if electronic), provided in a front or back cover circuit mounting area, or may be embedded in the spine of electronic book 20. A connector 27 is provided for uploading data and program instructions to internal electronics of electronic book 20, battery charging and so forth, whereby the actions of electronic display 23 can be initialized or updated by connection to an external computer. Connector 27 may be omitted for totally wireless embodiments, where a wireless interface as described below, provides the mechanism for uploading electronic book information.

Uses of the above-described embodiment include providing such electronic features as navigation controls and other items that stay fixed on electronic display 23, while other more dynamic information is provided on pages 22. Educational and conferencing uses are contemplated where fixed display 23 provides navigation, communication (i.e, messages from a teacher or conference participants) and fixed information, while pages 22 provide downloadable display of such information as presentations, class assignments, reading material, and so forth.

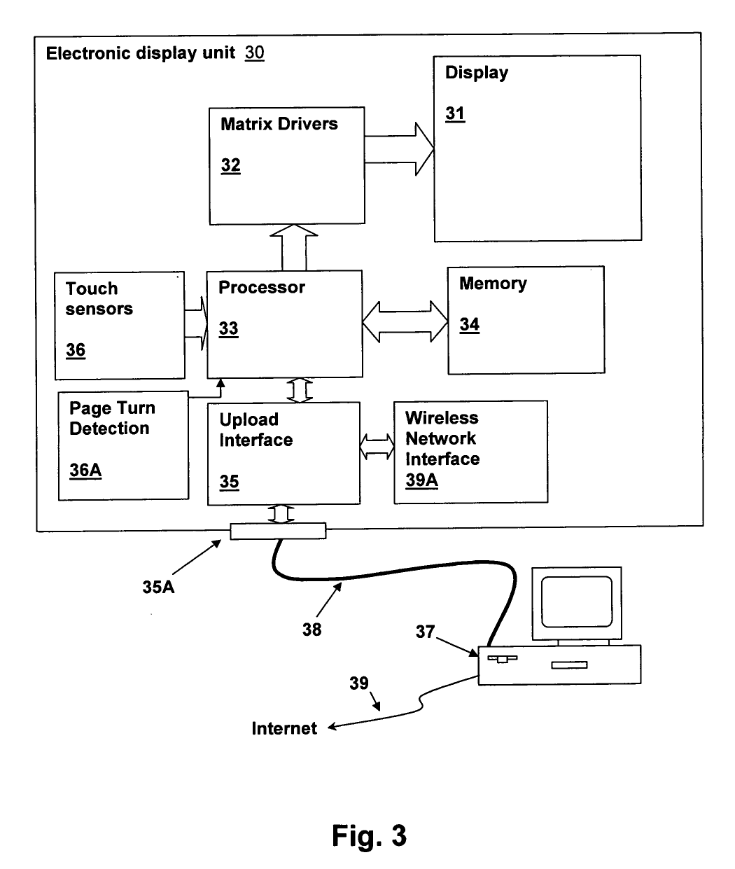

Referring now to FIG. 3, driver circuits suitable for use within electronic books 10 and 20 in accordance with an embodiment of the invention are shown in a block diagram. Display 31 which may be an electronic display area affixed to a page such as electronic display area 13 or a fixed electronic display 23, is coupled to a set of matrix drivers 32. Display 31 may comprise a plurality of electronic displays all connected to matrix driver 32 and may be individually selectable via matrix drivers 32. Matrix drivers 32 are coupled to processor 33 for receiving information corresponding to text and graphics displayed on display 31 and processor is coupled to a memory 34 for storing program instructions for execution by processor 33 and data corresponding to graphical and text images for display on display 31. An upload interface 35 is provided for connection via connector 35A and cable 38 to an external general-purpose computer 37, which may be connected to a network (such as the Internet) through a network connection 39, whereby updates or original scripts and graphics for operation of display 31 may be downloaded periodically. Wireless network connection 39A, provides a mechanism for wireless upload of data to electronic books 10 and 20 without a physical connection. The wireless embodiment is especially suitable for conference and educational applications as a recipient (or owner) of electronic books at such locations may receive to-the-minute updated materials. Touch sensors 36 and page turn detectors 36A are coupled to processor 33 for providing interactive input functionality as described above.

While the invention has been particularly shown and described with reference to the preferred embodiments thereof, it will be understood by those skilled in the art that the foregoing and other changes in form, and details may be made therein without departing from the spirit and scope of the invention.

1. An electronic book, comprising:
a plurality of turnable pages containing static printed book content; and
at least one multiple pixel electronic display affixed to a given face of a particular one of said turnable pages and occupying a portion of said given page less than an entire area of said given face for displaying dynamic book content, wherein the electronic display provides a dynamic first portion of a single page view of said given face and another portion of said single page view of said given face is provided by static content printed on said given face.

2. The electronic book of claim 1, wherein said at least one multiple pixel electronic display comprises a plurality of displays each affixed to associated ones of said plurality of turnable pages, whereby dynamic content is displayed on a selected one of said plurality of displays when an associated one or said plurality of turnable pages is selected as said single page view.

3-5. (canceled)

6. The electronic book of claim 1, further comprising a page detector coupled to the electronic display for detecting selection of said given face, whereby the electronic display is activated in response to selection of said given face.

7. The electronic book of claim 1, wherein said electronic display is an animated electronic display for providing an animation local to and visible upon said selected page.

8. The electronic book of claim 1, wherein said electronic display is an electronic display programmed with graphical representations providing at least one of navigational controls, communication controls and content controls.

9. The electronic book of claim 1, wherein said electronic display is a textual electronic display for providing changeable text information local to and visible upon said selected page.

10-12. (canceled)

13. A method for providing a page display of an electronic book, comprising:
first displaying one of a plurality of turnable pages having printed static content providing a first portion of a single page view; and
second displaying information simultaneously with said first displaying on a multiple pixel electronic display affixed to said displayed one of said plurality of turnable pages and covering only only a partial area of a face of said displayed turnable page, whereby said displayed information forms a second portion of said single page view.

14. (canceled)

15. The method of claim 13, further comprising detecting selection of said displayed printed page, and wherein said second displaying is performed in response to said detecting.

16-19. (canceled)

20. The method of claim 19, wherein said first second displaying displays at least one of navigational controls, communication controls and content controls.

21. An electronic book, comprising:
a plurality of turnable multiple pixel electronic display pages each forming part of a single-page view of said electronic book when selected for viewing; and
a second multiple pixel electronic display, wherein the second multiple pixel electronic display provides a second part of said single page view.

22. The electronic book of claim 21, further comprising a spindle assembly to which said plurality of turnable multiple pixel electronic displays and said second multiple pixel electronic display are attached, whereby said plurality of turnable displays are re-circulated.

23. The electronic book of claim 21, wherein said plurality of turnable multiple pixel electronic displays are flexible electronic displays.

24. The electronic book of claim 21, further comprising a page detector coupled to the plurality of turnable multiple pixel electronic displays for detecting selection of a given one of said turnable multiple pixel electronic displays, whereby said given display is activated in response to selection of said given display.

25. A method for providing a page display of an electronic book, comprising:
first displaying a given one of a plurality of turnable multiple pixel electronic displays providing a first portion of a single page view; and
second displaying information simultaneously with said first displaying on a second multiple pixel electronic display forming a second portion of said single page view.

26. The method of claim 25, further comprising detecting selection of said given display, and wherein said second displaying is performed in conformity with a result of said detecting.

27. The method of claim 25, further comprising detecting selection of said given display, and wherein said first displaying is performed in response to said detecting.

28. An electronic book, comprising:
a plurality of turnable pages, each particular one of said turnable pages forming a first portion of a single page view of said electronic book when said particular page is selected for viewing;
a multiple pixel electronic display forming a second portion of said single page view; and
a spindle assembly to which said plurality of turnable pages and said multiple pixel electronic display are attached, whereby said plurality of turnable pages are re-circulated.

29. The electronic book of claim 21, wherein said plurality of turnable pages comprise multiple pixel electronic displays.

30. A method for providing a page display of an electronic book, comprising:
first displaying a given one of a plurality of turnable pages providing a first portion of a single page view;
second displaying information simultaneously with said first displaying on a multiple pixel electronic display forming a second portion of said single page view; and
recirculating said plurality of turnable pages on a spindle when a terminal one of said turnable pages is reached.

31. The method of claim 30, further comprising detecting selection of said given page, and wherein said second displaying is performed in conformity with said detecting.
